(19) United States
(12) Patent Application Publication
(10) Pub. No.: US 2019/0343352 A1
(43) Pub. Date: Nov. 14, 2019

(54) AIR NOZZLES WITH BRISTLES AND SCRAPERS

(71) Applicant: Kenneth C. Stubbs, Hurricane, UT (US)

(72) Inventor: Kenneth C. Stubbs, Hurricane, UT (US)

(21) Appl. No.: 16/424,146

(22) Filed: May 28, 2019

Related U.S. Application Data
(63) Continuation-in-part of application No. 29/629,016, filed on Dec. 11, 2017, now Pat. No. D850043.
Application No. 29/629,016 is a continuation-in-part of application No. 29/629,017, filed on Dec. 11, 2017.

(51) Int. Cl. A47L 9/06; B08B 1/00

(52) U.S. Cl. CPC A47L 9/0673; B08B 1/005; B08B 1/002

(57) ABSTRACT

An air nozzle comprises a body, the body having a first end for coupling to an air gun, and a second end having bristles, the body having a channel therethrough allowing air (or other fluids) to pass therethrough. In one example, a scraper may be coupled to the second end in place of bristles. A user may then easily clean a surface using the bristles, scraper, and air or water.

### CROSS-REFERENCE TO RELATED APPLICATIONS

This application is a continuation-in-part of U.S. Design application Ser. No. 29/629,016, filed on Dec. 11, 2017, and is a further continuation-in-part of U.S. Design application Ser. No. 29/629,017, filed on Dec. 11, 2017, both of which are incorporated herein by reference.

### TECHNICAL FIELD

The present disclosure relates to air blow guns and water guns. More particularly, the present disclosure relates to interchangeable nozzles for air and water guns, the nozzles having a scraper or bristles.

### BACKGROUND

Pneumatic air blow guns and water spray guns are used extensively in a variety of fields. For example, air blow guns are used by auto mechanics, car detailers, computer repair technicians, and other fields. The nozzle allows a user to easily clean, blow out, or dry a work area. However, many times a user must select between desired tools. For example, a user may hold a part, such as a carburetor, in one hand, use an air gun to blow off debris, then switch to a brush or scraper to attempt to dislodge additional debris, then switch back to the air gun to blow the dislodged debris from the carburetor. Constantly switching between tools is both time-consuming and tiring. Further, a worker may use excessive chemicals and cleaners in an attempt to dislodge debris, when a bristle or scraper would be equally effective, or perhaps even more effective. Accordingly, there is a need for a device that is more efficient than the current art, allowing a user to clean faster and easier and reduce chemical and cleaner use. The air nozzles disclosed herein solve these and other problems.

### SUMMARY OF EXAMPLE EMBODIMENTS

In one embodiment, an air nozzle comprises a body, the body having a first end for coupling to an air gun, and a second end, the second end comprising bristles, the body having a channel therethrough, allowing air (or other fluids) to pass therethrough.

In one embodiment, an air nozzle comprises a body, the body having a first end for coupling to an air gun, and a second end, the second end comprising a scraper, the body having a channel therethrough, allowing air (or other fluids) to pass therethrough.

### BRIEF DESCRIPTION OF THE DRAWINGS

FIG. 1 is a side perspective view of the air nozzle with bristles;

FIG. 2 is a front elevation view of the air nozzle with bristles;

FIG. 3 is a back elevation view of the air nozzle with bristles;

FIG. 4 is a left side elevation view of the air nozzle with bristles;

FIG. 5 is a right side elevation view of the air nozzle with bristles;

FIG. 6 is a top plan view of the air nozzle with bristles;

FIG. 7 is a bottom plan view of the air nozzle with bristles;

FIG. 8 illustrates the air nozzle with bristles coupled to an air gun;

FIG. 9 is a side perspective view of the air nozzle with scraper;

FIG. 10 is a front elevation view of the air nozzle with scraper;

FIG. 11 is a back elevation view of the air nozzle with scraper;

FIG. 12 is a left side elevation view of the air nozzle with scraper;

FIG. 13 is a right side elevation view of the air nozzle with scraper;

FIG. 14 is a top plan view of the air nozzle with scraper;

FIG. 15 is a bottom plan view of the air nozzle with scraper; and

FIG. 16 illustrates the air nozzle with scraper coupled to an air gun.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a device that is more efficient than the current art, allowing a user to clean faster and easier. As appreciated from the below disclosure, the air nozzles with bristles and scrapers solve these and other problems.

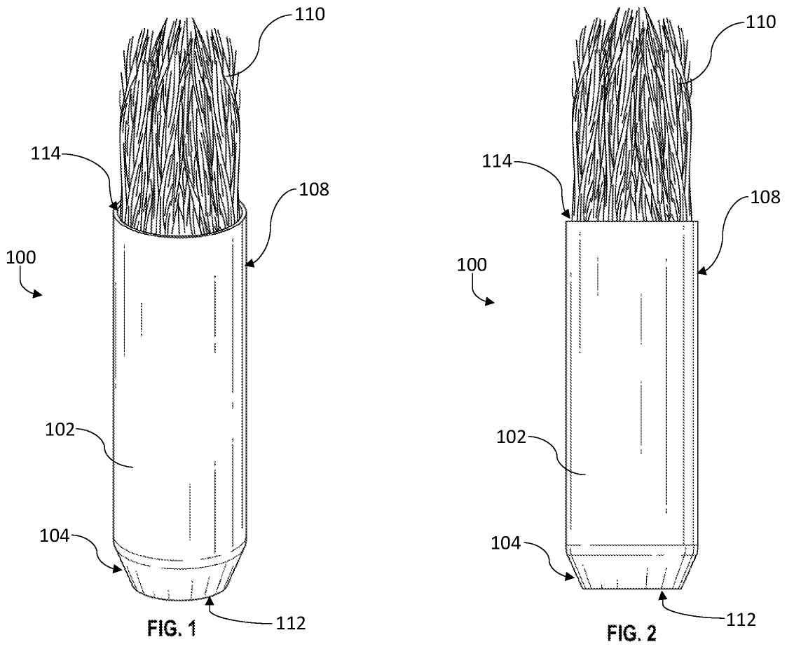

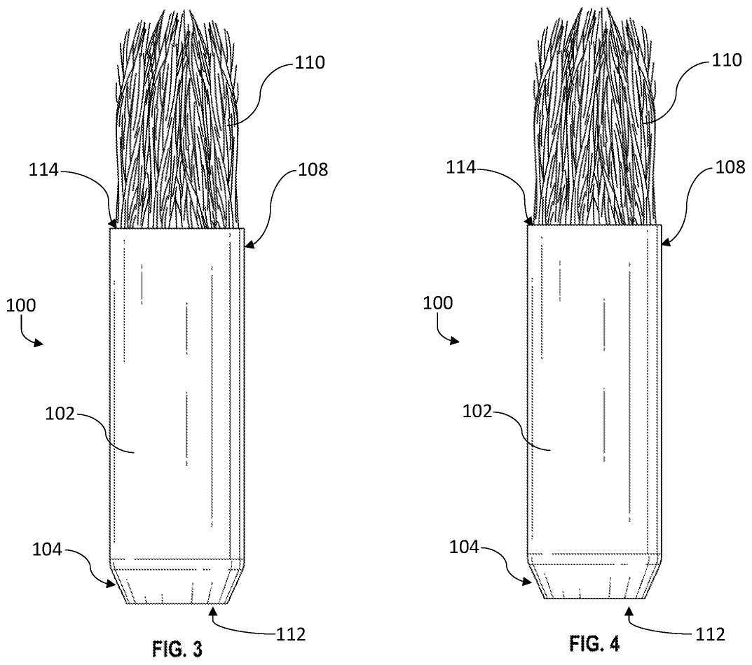

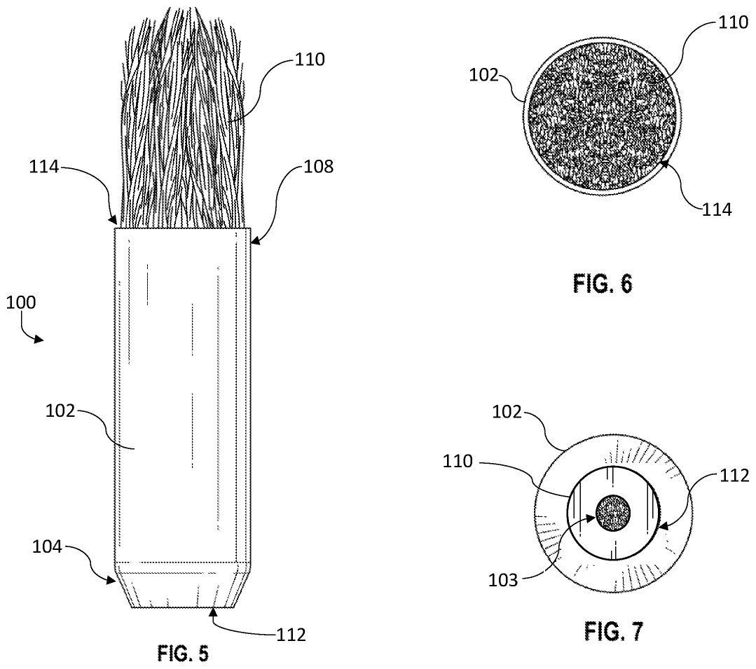

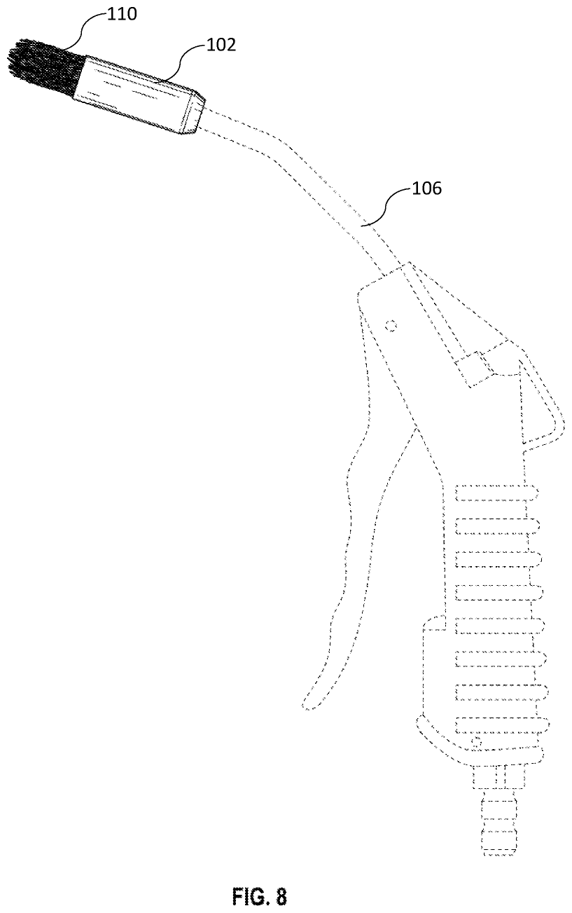

In one embodiment, as shown in FIGS. 1-8, an air nozzle 100 comprises a body 102, the body 102 having a first end 104 for coupling to an air gun 106 (FIG. 8), and a second end 108, the second end 108 comprising bristles 110. The body 102 is hollow or otherwise has a channel 103 passing therethrough, having a bottom opening 112 and a top opening 114 allowing for the passage of the air or water. The bottom opening 112 receives the air gun 106 as shown in FIG. 8. The top opening 114 may be unobstructed or may also comprise bristles 110. The second end 108 may comprise a plurality of bristle apertures for tufting (not visible due to the bristles 110 in the Figs., but understood in the art of tufting brushes and bristles). For example, in one embodiment, the bristles 110 may be coupled to the body 102 using bristle tufting known in the art of brush making, wherein a plurality of bristles is forced into a bristle aperture on the second end 108. The bristles 110 may remain in place through compression alone, or may have other securing means, such as adhesives. The body 102 may be made from plastics, metals, carbon fibers, woods, or any other suitable material.

Accordingly, air (or other fluid, such as water) may enter through the bottom opening 112, pass through channel 103, through bristles 110, and out of the nozzle 100. This allows a user to apply water or air while simultaneously using the bristles 110. As will be appreciated, this allows a user to work more efficiently by consolidating multiple tools into one. It also reduces the reliance on chemicals or other cleaners.

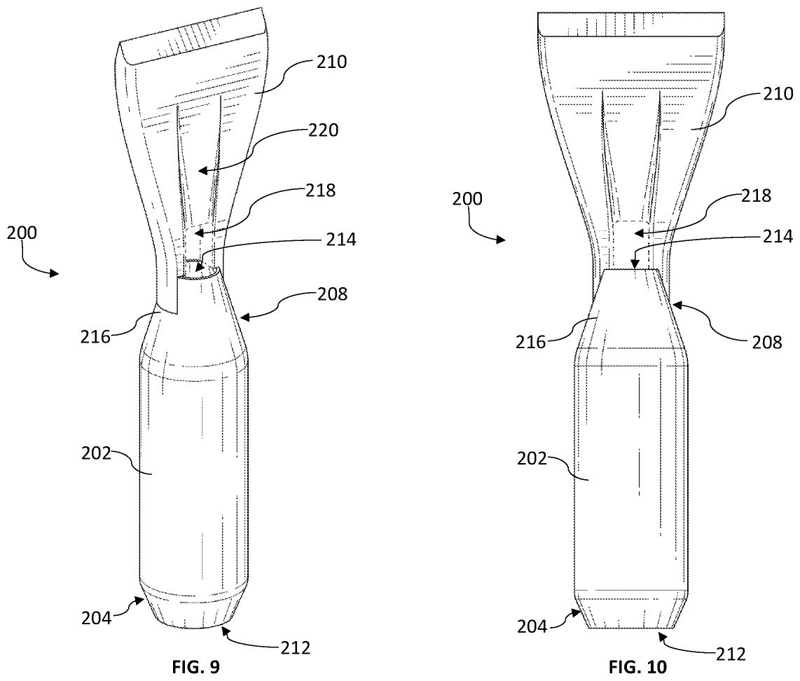

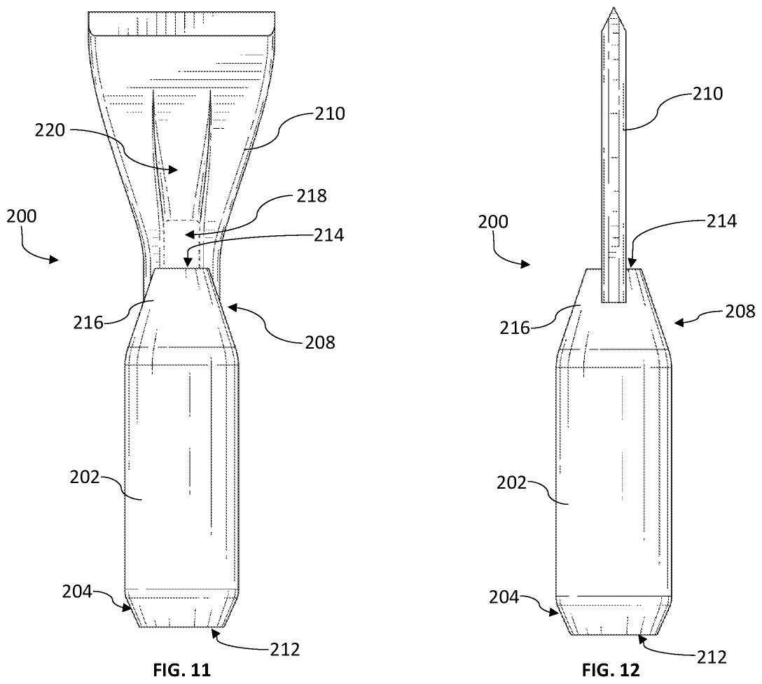

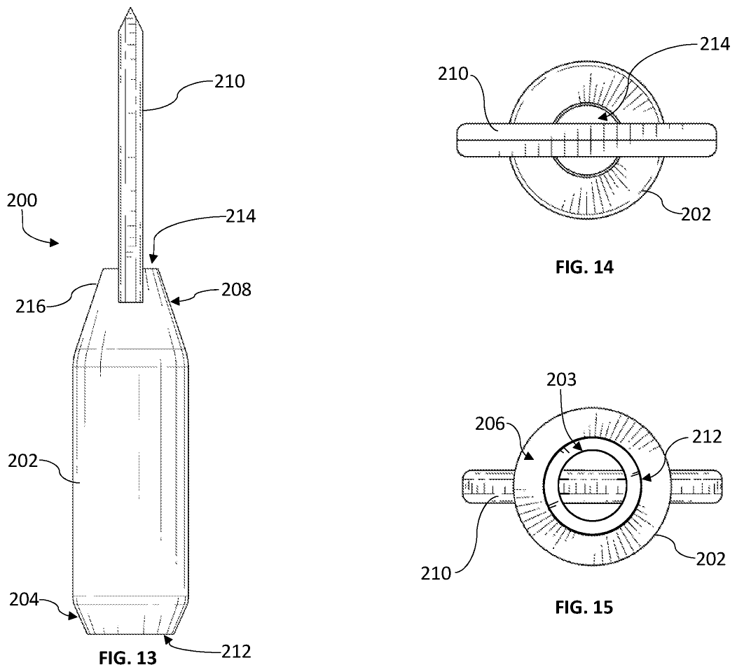

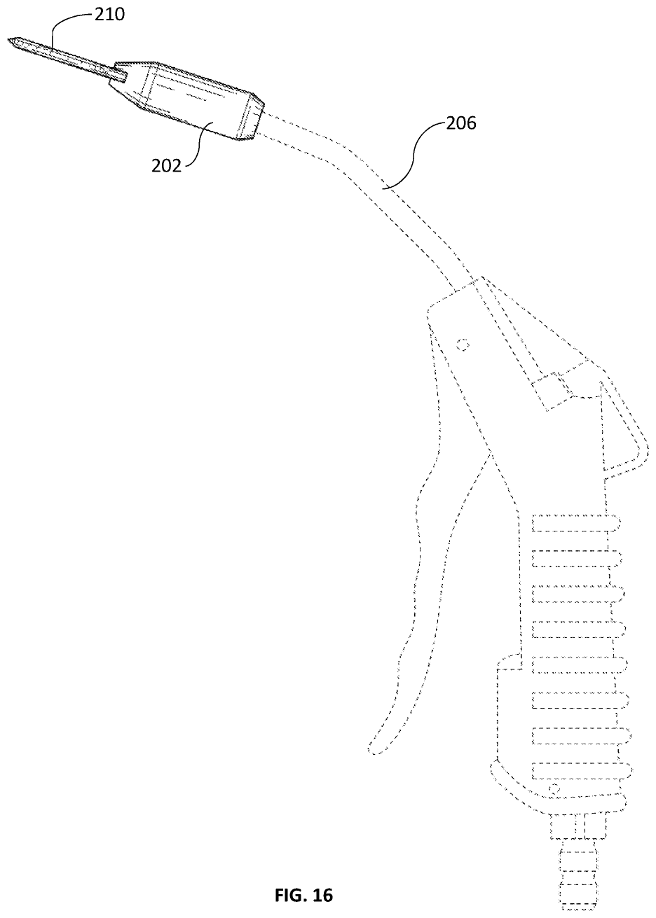

In one embodiment, as shown in FIGS. 9-16, an air nozzle 200 comprises a body 202, the body 202 having a first end 204 for coupling to an air gun 206 (FIG. 16), and a second end 208, the second end 208 comprising a scraper 210. The body 202 is hollow or otherwise has a channel 203 (FIG. 14) passing therethrough, having a bottom opening 212 and a top opening 214. The bottom opening 212 receives the air gun 206 as shown in FIG. 16. The top opening 214 is coupled to the scraper 210. In one embodiment, the scraper 210 is secured to the outer walls 216 of the body 202, such as by using adhesives. The scraper 210 may comprise an air aperture 218, allowing the air to exit the hollow body 202 more easily. In one embodiment, the scraper 210 comprises a recessed section to allow the passage of air, rather than comprising air aperture 218 passing through the scraper 210, forming a hole or gap in the scraper 210. The scraper 210 may have recessed air channels 220 that aid in guiding the air or water to the distal end of the scraper 210. Accordingly, water or air enters through bottom opening 212, passes through channel 203, and exits at top opening 214. It may then be guided by the channels 220 to the distal, working end, of the scraper 210. As appreciated, this allows faster, more efficient cleaning and scraping, and reduces the use of harsh chemicals and cleaners.

In another embodiment, the scraper 210 may be coupled to the body 210 by inserting a first end of the scraper into the top opening 214. It may be secured therein using threads (e.g., the scraper 210 may have a threaded end for receiving into a threaded top opening 214), adhesives, rivets, or other securing mechanisms. It will be appreciated that the scraper 110 is not limited to a particular form factor and may be configured to the desired industry use. Ideally the scraper 210 is manufactured from metals. However, other materials, such as hard plastics, carbon fibers, and other materials may be used to manufacture the scraper.

As shown in the figures, the body 102, 202 may be cylindrical; however, other formfactors may be used without departing herefrom.

In one embodiment, a method of use comprises coupling an air nozzle to an air or water gun, and, while air or water is passing therethrough, using the bristles or scraper to contact the desired working surface. As will be understood, this allows more efficient cleaning of the desired surface or component. The many uses of the air nozzles described herein will be appreciated. For example, the air nozzles 100, 200 described herein may be used for car detailing, electronics cleaning, mechanical engineering and processes, general cleaning, paint stripping, archeological work, etc. Further, it will be appreciated that while referred to as an “air nozzle,” the present invention is not so limited. In other words, the nozzles may be used with air, water, liquid cleaners, gases, and other fluids.

While the air nozzles shown and described herein are removably attachable to an air or water gun, such configuration is not required. In other words, the gun may be constructed with the air nozzle 100, 200 irremovably attached thereto (i.e., integral to the gun).

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. An air nozzle, comprising:
a body having a first end and a second end, wherein the first end comprises a bottom opening for receiving an air or water gun and the second end comprises a plurality of bristles; the body having a channel from the bottom opening to a top opening on the second end for the passage of air or water.

2. The air nozzle of claim 1, wherein the body is cylindrical.

3. The air nozzle of claim 1, wherein the bristles are coupled to the second end via tufting.

4. The air nozzle of claim 1, wherein the air nozzle is permanently coupled to an air or water gun.

5. An air nozzle, comprising:
a body having a first end and a second end, wherein the first end comprises a bottom opening for receiving an air or water gun and the second end comprises a top opening comprising a scraper; the body having a channel from the bottom opening to the top opening for the passage of air or water.

6. The air nozzle of claim 5, wherein the scraper is coupled to the outer walls of the body.

7. The air nozzle of claim 5, wherein the scraper comprises an air aperture.

8. The air nozzle of claim 5, wherein the air nozzle is permanently coupled to an air or water gun.

9. The air nozzle of claim 5, wherein the scraper comprises one or more air channels.
